(19) United States
(12) Patent Application Publication
(10) Pub. No.: US 2022/0134259 A1
(43) Pub. Date: May 5, 2022

(54) COALESCING MEDIA FOR HYDRONIC AIR AND SEDIMENT SEPARATION DEVICE

(71) Applicant: FLUID HANDLING LLC, Morton Grove, IL (US)

(72) Inventors: Thomas TURTON, West Seneca, NY (US); Stanley Paul EVANS, JR., Tinley Park, IL (US); Scott D. MOSHER, Ovid, NY (US); Christopher C. KERBACK, Woodridge, IL (US); Mrinalini LITORIYA, Telangana (IN)

(21) Appl. No.: 17/518,698

(22) Filed: Nov. 4, 2021

Related U.S. Application Data
(60) Provisional application No. 63/109,472, filed on Nov. 4, 2020.

(51) Int. Cl. B01D 21/00; B01D 21/02; B01D 19/00

(52) U.S. Cl. CPC B01D 21/0042; B01D 21/0069; B01D 21/0045; B01D 19/0042; B01D 21/02

(57) ABSTRACT

A coalescing removal separator includes a separator tank and a coalescing media. The separator tank has a separator input that receives a fluid flowing through an HVAC system having entrained gas and solid particles, has a tank wall that forms a volume/chamber inside the separator tank to process the fluid, and has a separator output that provides processed fluid having at least some, most or substantially all of the entrained gas and solid particles removed. The coalescing media is arranged in the volume/chamber of the separator tank, has a series of vertically aligned corrugated perforated sheets substantially filling the volume/chamber of the separator tank and removes the at least some, most or substantially all of the entrained gas and solid particles from the fluid.

### CROSS-REFERENCE TO RELATED APPLICATION

This application claims benefit to provisional patent application Ser. No. 63/109,472, filed 4 Nov. 2020, which is hereby incorporated by reference in its entirety.

### BACKGROUND OF THE INVENTION

### 1. Field of the Invention

The present invention relates to a coalescing media; and more particularly relates to a coalescing media for a hydronic air and sediment separation device.

### 2. Brief Description of Related Art

Coalescing removal separators are devices typically installed on hydronic HVAC systems to remove entrained gases (such as air) and solid particles (such as iron oxide) from the fluid flowing through the system. Gasses trapped in a hydronic system lead to potentially harmful corrosion. Solid particulates collect into sediment that can foul moving components in pumps or valves and damage sensors in the system.

Coalescing removal separators work by passing the system fluid into a tank, through a coalescent media, and back to the system. The action of passing the fluid through the coalescent media enables the entrained gasses and particles to be removed from the system. The coalescent media disrupts the fluid flow and slows the fluid velocity, which allows gas bubbles to come out of solution and, through their natural buoyancy, float to the top of the separator tank to be vented out of the system. Likewise, the reduction in fluid velocity allows solids in the fluid, which are heavier than the system fluid, to come out of solution and drop to the bottom of the tank to be later removed through a blow-down action. The blow-down action involves opening a valve at the bottom of the removal separator tank to atmosphere, utilizing the difference between atmospheric pressure and the system pressure inside the separator tank to force out the solid contaminants that have come out of solution as they passed through the coalescing media. The coalescent media also provides a surface for dissolved gasses and solids to collect, or coalesce, around. As more dissolved gas or solids pass through the media pack, the molecules will continue to coalesce until they are either buoyant enough to float to the top or heavy enough to drop to the bottom.

### SHORTCOMINGS OF THE ABOVE MENTIONED KNOWN DEVICES

One problem with current coalescing removal separator media is that they significantly increase the pressure drop of the unit, which can negatively impact the overall system efficiency. Another issue is that they may not effectively remove gasses or solids due to their designs.

In view of the aforementioned, there is a need in the industry for a better coalescing media for a hydronic air and sediment separation device.

### SUMMARY OF THE INVENTION

The present invention provides a new and unique coalescing separator media that improves the pressure drop characteristics across the separator while improving the ability of the device to more effectively remove gasses and solids from the system fluid. By way of example, this media consists of a series of vertically aligned corrugated perforated sheets, e.g., made from stainless steel, arranged such that they fill a large portion of the volume of the separator tank. The corrugated sheets are assembled to each other where the peak of one corrugation is assembled to the crest of the other. The corrugations could also be assembled peak-to-peak and crest-to-crest. The perforated and corrugated sheets have an open area of 58% or greater, which facilitate the improved pressure drop characteristics.

The fluid flows through the corrugated media makes contact with the face of the perforated material to slow down the fluid velocity, enabling the entrained gasses and solids to come out of solution and either rise or sink, respectively. The perforations of the corrugated sheet media provide multiple surfaces for dissolved gasses and solids to coalesce around.

The vertically aligned corrugations of the coalescing media serve two purposes.

First, the angled corrugations direct the fluid to pass through the coalescing media where the greatest surface contact could occur. Likewise, as the fluid has completed its pass through the coalescing media, the angled corrugations direct the fluid to the discharge nozzle to leave the separator, and allow the pressure drop to recover. These motions help reduce the overall pressure drop of the coalescing separator, compared to different designs.

Second, the vertically aligned corrugations are rigid and resist the compressive forces that the coalescing media would be subject to over the course of its operational lifetime. They are also resistant to any rotation.

The corrugated coalescing separator media is to be retained within the separator tank by a tank head at the top and at least one retaining bar at the bottom. This provides sufficient open area to permit gas bubbles to rise to the top of the separator and solids to fall to the bottom.

### SPECIFIC EMBODIMENTS

According to some embodiments, the present invention may take the form of apparatus featuring a coalescing removal separator having a combination of a separator tank and a coalescing media.

The separator tank has a separator input configured to receive a fluid flowing through a system having entrained gas and solid particles, has a tank wall configured to form a volume/chamber inside the separator tank to process the fluid, and has a separator output configured to provide processed fluid having at least some, most or substantially all of the entrained gas and solid particles removed.

The coalescing media is arranged in the volume/chamber of the separator tank, has a series of vertically aligned corrugated perforated sheets substantially filling the volume/chamber of the separator tank and is configured to remove the at least some, most or substantially all of the entrained gas and solid particles from the fluid.

The apparatus may also include one or more of the following features:

The series of vertically aligned corrugated perforated sheets may be made from a metallic material, such as stainless steel.

The series of vertically aligned corrugated perforated sheets may have peaks and crests, and may be assembled to each other where a peak of one corrugation is assembled to a crest of another corrugation.

The series of vertically aligned corrugated perforated sheets may have peaks and crests, and may be assembled to each other peak-to-peak and crest-to-crest.

The series of vertically aligned corrugated perforated sheets may have an open area of about 58% or greater, which facilitates an associated pressure drop characteristics.

The series of vertically aligned corrugated perforated sheets may have perforations that provide multiple surfaces for dissolved gasses and solids to coalesce around.

The series of vertically aligned corrugated perforated sheets may have angled corrugations that direct the fluid to pass through the coalescing media where greatest surface contact occurs.

As the fluid has completed its pass through the coalescing media, the angled corrugations may direct the fluid to the separator output to leave the coalescing removal separator and allow a pressure drop to recover.

The series of vertically aligned corrugated perforated sheets may have vertically aligned corrugations that are rigid and resist compressive and/or rotation forces that the coalescing media is subject to within the separator tank.

The separator tank may include a top portion having a tank head configured to retain a corresponding bottom portion of the coalescing media; and a bottom portion having at least one retaining bar configured to retain a corresponding top portion of the coalescing media.

The top portion and the bottom portion may be configured to provide a sufficient open area to permit gas bubbles to rise to the top of the separator tank and solids to fall to the bottom of the separator tank.

The apparatus is, or take the form of, an HVAC system.

### BRIEF DESCRIPTION OF THE DRAWING

The drawing, which is not necessarily drawn to scale, includes the following Figures:

FIG. 1 is a perspective view of coalescing media having rectangular corrugation, according to some embodiments of the present invention.

FIG. 2 is a side cross-sectional view of a hydronic air and sediment separation device having coalescing media arranged therein, according to some embodiments of the present invention.

FIG. 3 is a top cross-sectional view of the hydronic air and sediment separation device shown in FIG. 2 along lines 3-3.

FIG. 4 is a top cross-sectional view of the hydronic air and sediment separation device shown in FIG. 3 showing fluid velocity vectors Vv as the fluid passes through the separator tank having the coalescing media arranged therein.

FIG. 5 includes FIGS. 5A and 5B, where FIG. 5A is a front side cross-sectional view of the hydronic air and sediment separation device shown in FIG. 2 showing fluid velocity vectors; and where FIG. 5B is a right side cross-sectional view of the hydronic air and sediment separation device shown in FIG. 2 showing fluid velocity vectors.

FIG. 6A is a side view of an individual corrugation that forms part of the coalescing media shown in FIG. 1.

FIG. 6B is a top down view of the individual corrugation shown in FIG. 6A.

FIG. 7 is a diagram the hydronic air and sediment separation device having the coalescing media arranged therein, according to some embodiments of the present invention.

FIG. 8 is a diagram of flow in relation to coalescing media having hexagon corrugations, according to some embodiments of the present invention.

FIG. 9 is a diagram of flow in relation to coalescing media also having hexagon corrugations different than that shown in FIG. 8 and forming a honeycomb configuration, according to some embodiments of the present invention.

FIG. 10 includes FIGS. 10A and 10B having alternative corrugation profiles forming honeycomb configurations, where FIG. 10A is a diagram of coalescing media having a honeycomb configuration, according to some embodiments of the present invention; and where FIG. 10B is a diagram of coalescing media having a honeycomb configuration, according to some embodiments of the present invention.

FIG. 11 is a block diagram of an HVAC system having a coalescing removal separator, according to some embodiments of the present invention.

Similar parts or components in Figures are labeled with similar reference numerals and labels for consistency. Every lead line and associated reference label for every element is not included in every Figure of the drawing to reduce clutter in the drawing as a whole.

### DETAILED DESCRIPTION OF THE INVENTION

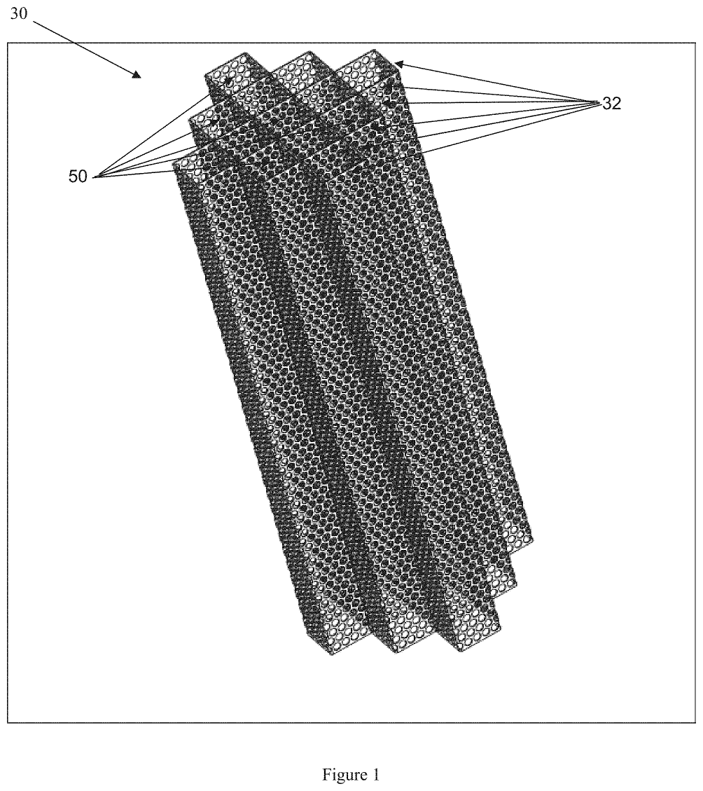

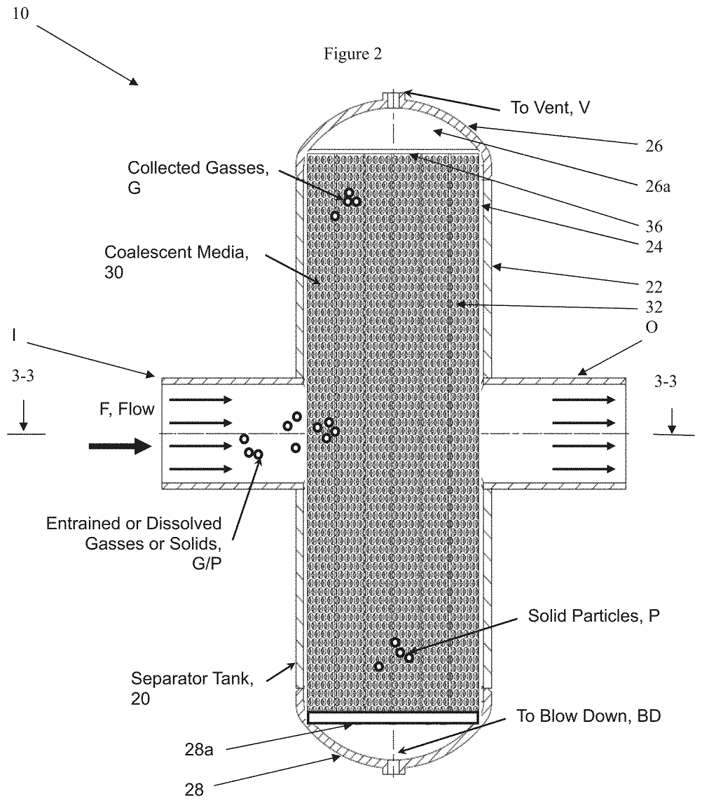

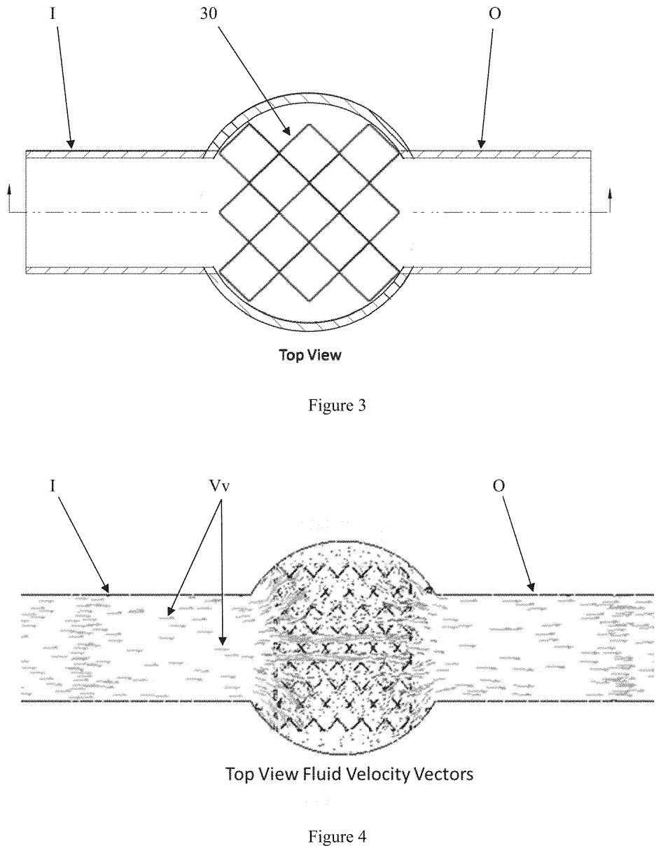

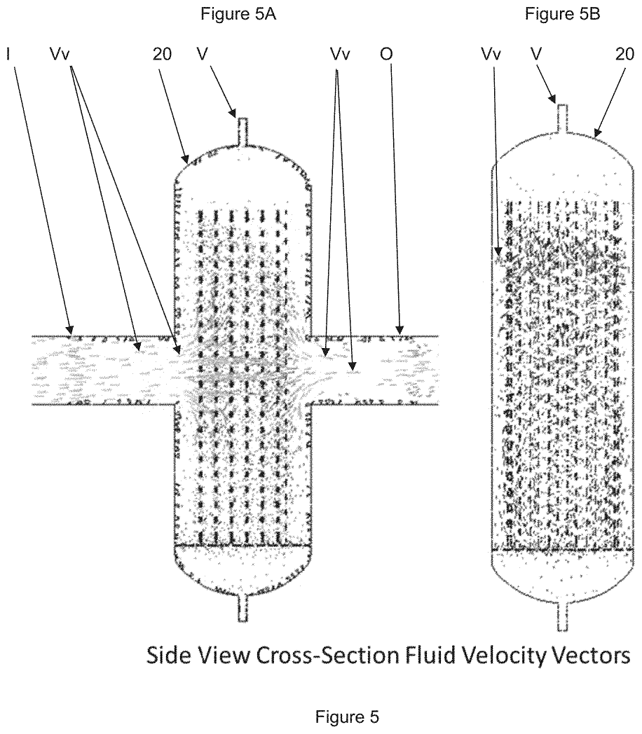

According to some embodiments, the present invention may take the form of apparatus featuring a coalescing removal separator generally indicated as 10 having a combination of a separator tank 20 and a coalescing media 30, e.g., as shown in FIGS. 1-2.

The separator tank 20 has a separator input I configured to receive a fluid flowing through a system having entrained gas and solid particles G/P, has a tank wall 22 configured to form a volume/chamber 24 inside the separator tank 20 to process the fluid F, and has a separator output O configured to provide processed fluid F having at least some, most or substantially all of the entrained gas and solid particles G/P removed.

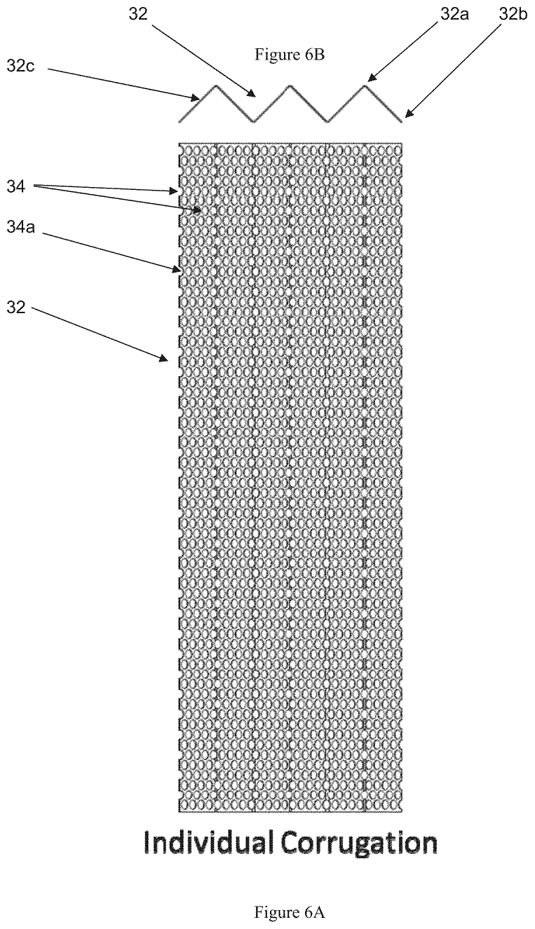

The coalescing media 30 is arranged in the volume/chamber 24 of the separator tank 20, has a series of vertically aligned corrugated perforated sheets 32 (see FIG. 6A, 6B) substantially filling the volume/chamber 24 of the separator tank 20 and is configured to remove the at least some, most or substantially all of the entrained gas and solid particles G/P from the fluid F.

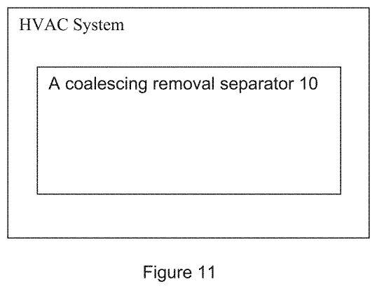

By way of example, the apparatus may take the form of an HVAC system (FIG. 11) having the coalescing removal separator.

FIG. 1 shows the coalescing media 30 having a series of six (6) vertically aligned corrugated perforated sheets 32, e.g., according to some embodiments of the present invention. Each vertically aligned corrugated perforated sheet 32 is also known herein as an individual corrugation as shown in FIGS. 6A and 6B. However, the scope of the invention is intended to include, and embodiments are envisioned that include, the coalescing media 30 having more or less than six vertically aligned corrugated perforated sheets 32. In FIG. 2, all six (6) vertically aligned corrugated perforated sheets 32 are the same, e.g., including the same size, shape and dimension.

The series of vertically aligned corrugated perforated sheets 32 may have peaks 32a, crests 32b and surfaces 32c inbetween, and may be assembled to each other where a peak 32a of one corrugation is assembled to a crest 32b of another corrugation. Alternatively, the series of vertically aligned corrugated perforated sheets 32 having the peaks 32a and crests 32b may be assembled to each other peak-to-peak and crest-to-crest. In other words, the scope of the invention is not intended to be limited to any particular alignment of peaks and crests of the vertically aligned corrugated perforated sheets 32. In FIGS. 1, 2 and 6A and 6B, each vertically aligned corrugated perforated sheet 32 has three (3) peaks 32a, four (4) crests 32b and six (6) surfaces 32c inbetween. (The terms “peaks” and “crests” may be used interchangeably within the spirit of the invention.)

The series of vertically aligned corrugated perforated sheets 32 may have multiple openings or perforations 34 that provide multiple surfaces 34a for dissolved gasses G and solids or particles P to coalesce around. By way of example, and consistent with that shown in FIGS. 1, 2, 6A, 6B, the multiple openings or perforations 34 may be circular openings or perforations and the multiple surfaces 34a may be circular or cylindrical surfaces, e.g., so as to be uniformly configured on the vertically aligned corrugated perforated sheets 32. However, the scope of the invention is intended to include, and embodiments are envisioned that include, the multiple openings or perforations 34 and the multiple surfaces 34a having different types or kinds of shapes and surfaces within the spirit of the underlying invention, e.g., including a triangular shape and surface, a rectangular shape and surface, a square shape and surface, a hexagon shape and surface, etc. In other words, the scope of the invention is not intended to be limited to the shape of the opening or perforation 34 and its associated surface 34a. For example, in one type of application the multiple openings or perforations 34 may have one shape and surface, while in another another application, the multiple openings or perforations 34 may have another shape and surface, as one skilled in the art would appreciate.

Moreover, and by way of further example, and consistent with that shown in FIGS. 1, 2, 6A, 6B, the multiple openings or perforations 34 may be configured or dimensioned having the same size, e.g., so as to be uniformly distributed on the vertically aligned corrugated perforated sheets 32. However, the scope of the invention is intended to include, and embodiments are envisioned that include, the multiple openings or perforations 34 having different sizes within the spirit of the underlying invention. Moreover, the scope of the invention is not intended to be limited to the size of the multiple openings or perforations 34, e.g., which may be configured or dimensioned with a particular size based upon a particular application as one skilled in the would appreciate. For example, in one type of application the multiple openings or perforations 34 may have one size or dimension, while in another another application, the multiple openings or perforations 34 may have another and different size or dimension.

Moreover still, and by way of still further example, and consistent with that shown in FIGS. 1, 2, 6A, 6B, the multiple openings or perforations 34 may be configured, dimensioned or spaced in relation to one another having the same distance inbetween, e.g., so as to be uniformly distributed on the vertically aligned corrugated perforated sheets 32. However, the scope of the invention is intended to include, and embodiments are envisioned that include, the multiple openings or perforations 34 having different distances inbetween within the spirit of the underlying invention. Moreover, the scope of the invention is not intended to be limited to any particular distances inbetween the multiple openings or perforations 34, e.g., which may be configured or dimensioned with a particular distance inbetween based upon a particular application as one skilled in the would appreciate. For example, in one type of application the multiple openings or perforations 34 may have one distance inbetween, while in another application, the multiple openings or perforations 34 may have another and and different distance inbetween.

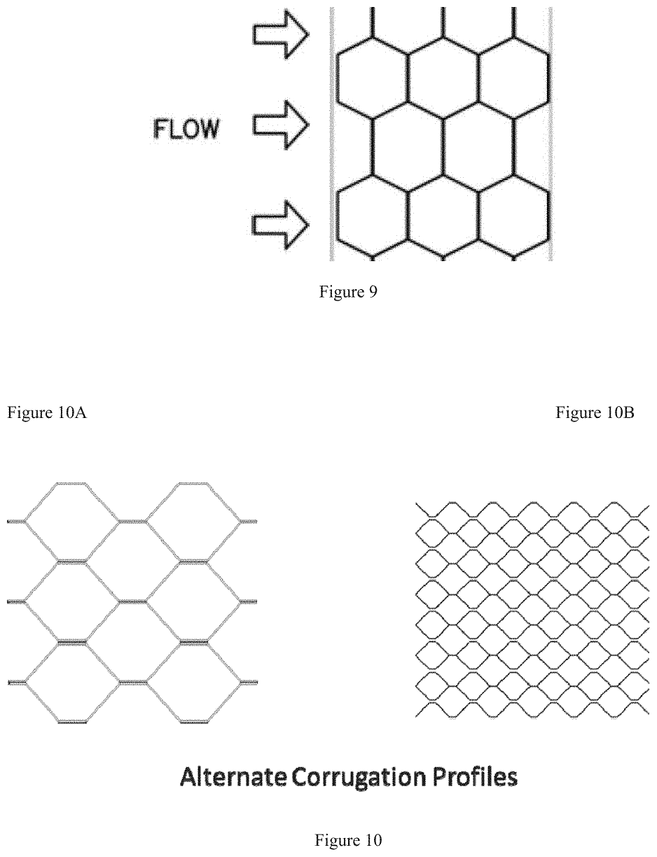

The series of vertically aligned corrugated perforated sheets 32 may have angled corrugations that direct the fluid to pass through the coalescing media 30 where greatest surface contact occurs. By way of example, and consistent with that shown in FIGS. 1, 2, 6A and 6B, the vertically aligned corrugated perforated sheets 32 have angled corrugations with a 90° angle (i.e. right angle). As the fluid has completed its pass through the coalescing media 30, the angled corrugations may direct the fluid to the separator output O to leave the coalescing removal separator 10 and allow a pressure drop to recover. However, the scope of the invention is intended to include, and embodiments are envisioned that include, the angled corrugations having a different angle within the spirit of the underlying invention. For example, the scope of the invention is intended to include, and embodiments are envisioned that include, the angled corrugations being more or less than 90°, e.g., so as to be configured or dimensioned with a particular angled corrugation based upon a particular application as one skilled in the would appreciate. For example, in one type of application the angled corrugation may have one angle, while in another another application, the angled corrugation may have another and different angle. Moreover, and by way of further example, FIG. 9 shows a coalescing media having vertically aligned corrugated perforated sheets with angles greater than 90° so as to form a honeycomb configuration, e.g., with an angle of about 120°.

The series of vertically aligned corrugated perforated sheets 32 may have vertically aligned corrugations that are rigid and resist compressive and/or rotation forces that the coalescing media 30 is subject to within the separator tank 20. By way of example, the series of vertically aligned corrugated perforated sheets 32 may be made from a metallic material, such as stainless steel. However, the scope of the invention is intended to include, and embodiments are envisioned that include, the series of vertically aligned corrugated perforated sheets 32 being made from other types or kinds of material, e.g., including other metal or non-metallic material within the spirit of the underlying invention. For example, in one type of application the series of vertically aligned corrugated perforated sheets 32 may be made from one type of material, while in another application, the series of vertically aligned corrugated perforated sheets 32 may be made from one another and different material, e.g., as one skilled in the art would appreciate.

The separator tank 20 may include a top portion 26 having a tank head 26a configured to retain a corresponding top portion 36 of the coalescing media 30; and a bottom portion 28 having at least one retaining bar 28a configured to retain a corresponding bottom portion 38 of the coalescing media 30.

The at least one retaining bar 28a may include two or more retainer bars 28a, e.g., depending on the application. For example, in one application, one retainer bar 28 may be configured to retain the corresponding bottom portion 38 of the coalescing media 30, while in another application, two or more retainer bars 28 may be configured to retain the corresponding bottom portion 38 of the coalescing media 30. The scope of the invention is not intended to be limited to the number of retainer bars used to retain the corresponding bottom portion 38 of the coalescing media 30.

The top portion 26 and the bottom portion 28 may be configured to provide a sufficient open area to permit gas bubbles G to rise to the top of the separator tank 20 and solids or particles P to fall to the bottom of the separator tank 20. In FIG. 2, the separator tank 20 also may include a vent V configured or formed in the top portion 26 for providing the gas bubbles G from the separator tank 20, and may include a blow-down BD configured or formed in the bottom portion 28 for providing the solids or particles P from the separator tank 20.

By way of example, the series of vertically aligned corrugated perforated sheets 32 may have an open area of about 58% or greater, which facilitates an associated pressure drop characteristics. The open area may be configured or formed by the openings generally indicated by 50 (FIG. 1) configured or formed between the series of six vertically aligned corrugated perforated sheets 32. FIG. 1 includes arrows pointing to five (5) of the thirteen (13) openings configured or formed between the series of six vertically aligned corrugated perforated sheets 32.

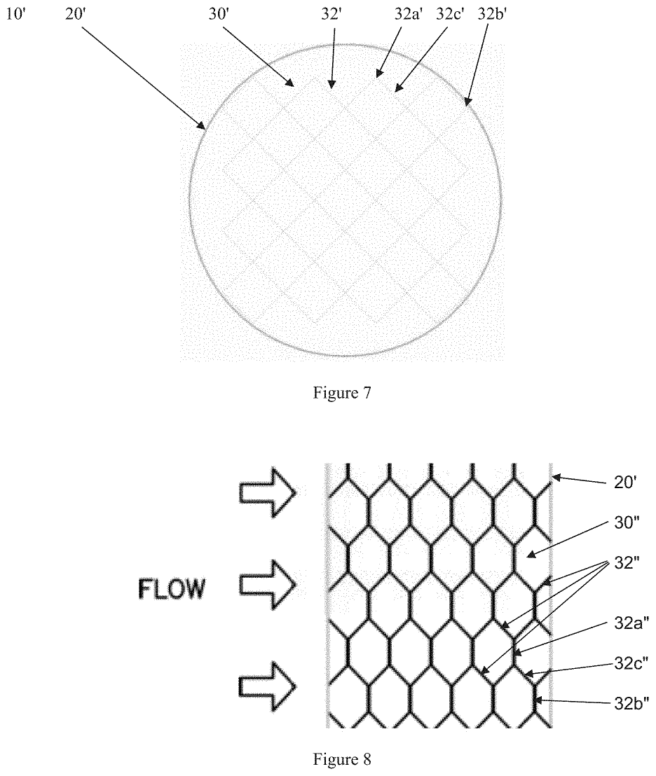

### FIG. 7

FIG. 7 shows a hydronic air and sediment separation device 10′ having a separator tank 20′ with a coalescing media 30′ arranged therein, according to some embodiments of the present invention. In FIG. 7, the coalescing media 30′ has eight (8) vertically aligned corrugated perforated sheets 32′, each having four (4) peaks 32a′, five (5) crests 32b′ and eight (8) surfaces 32c′ inbetween.

### FIG. 8

FIG. 8 shows a separator tank 20″ having a coalescing media 30″ arranged therein with hexagon corrugations, according to some embodiments of the present invention. In FIG. 8, the coalescing media 30′ has eleven (11) vertically aligned corrugated perforated sheets 32″, each having corresponding peaks 32a″, crests 32b″and surfaces 32c″ inbetween configured in a honeycomb formation having a peak-to-peak and crest-to-crest assembly.

### The Scope of the Invention

The embodiments shown and described in detail herein are provided by way of example only; and the scope of the invention is not intended to be limited to the particular configurations, dimensionalities, and/or design details of these parts or elements included herein. In other words, one skilled in the art would appreciate that design changes to these embodiments may be made and such that the resulting embodiments would be different than the embodiments disclosed herein, but would still be within the overall spirit of the present invention.

It should be understood that, unless stated otherwise herein, any of the features, characteristics, alternatives or modifications described regarding a particular embodiment herein may also be applied, used, or incorporated with any other embodiment described herein.

Although the invention has been described and illustrated with respect to exemplary embodiments thereof, the foregoing and various other additions and omissions may be made therein and thereto without departing from the spirit and scope of the present invention.

What we claim is:

1. Apparatus comprising:
a coalescing removal separator that includes:
a separator tank having a separator input configured to receive a fluid flowing through a system having entrained gas and solid particles, having a tank wall configured to form a volume/chamber inside the separator tank to process the fluid, and having a separator output configured to provide processed fluid having at least some, most or substantially all of the entrained gas and solid particles removed; and
a coalescing media arranged in the volume/chamber of the separator tank, the coalescing media having a series of vertically aligned corrugated perforated sheets substantially filling the volume/chamber of the separator tank and configured to remove the at least some, most or substantially all of the entrained gas and solid particles from the fluid.

2. Apparatus according to claim 1, wherein the series of vertically aligned corrugated perforated sheets are made from stainless steel.

3. Apparatus according to claim 1, wherein the series of vertically aligned corrugated perforated sheets have peaks and crests, and are assembled to each other where a peak of one corrugation is assembled to a crest of another corrugation.

4. Apparatus according to claim 1, wherein the series of vertically aligned corrugated perforated sheets have peaks and crests, and are assembled to each other peak-to-peak and crest-to-crest.

5. Apparatus according to claim 1, wherein the series of vertically aligned corrugated perforated sheets have an open area of about 58% or greater, which facilitates an associated pressure drop characteristics.

6. Apparatus according to claim 1, wherein the series of vertically aligned corrugated perforated sheets have perforations that provide multiple surfaces for dissolved gasses and solids to coalesce around.

7. Apparatus according to claim 1, wherein the series of vertically aligned corrugated perforated sheets have angled corrugations that direct the fluid to pass through the coalescing media where greatest surface contact occurs.

8. Apparatus according to claim 7, wherein, as the fluid has completed its pass through the coalescing media, the angled corrugations direct the fluid to the separator output to leave the coalescing removal separator and allow a pressure drop to recover.

9. Apparatus according to claim 1, wherein the series of vertically aligned corrugated perforated sheets have vertically aligned corrugations that are rigid and resist compressive and/or rotation forces that the coalescing media is subject to within the separator tank.

10. Apparatus according to claim 1, wherein the separator tank comprises:
a top portion having a tank head configured to retain a corresponding top portion of the coalescing media; and
a bottom portion having at least one retaining bar configured to retain a corresponding bottom portion of the coalescing media.

11. Apparatus according to claim 10, wherein the top portion and the bottom portion are configured to provide a sufficient open area to permit gas bubbles to rise to the top of the separator tank and solids to fall to the bottom of the separator tank.

12. Apparatus according to claim 1, wherein the apparatus is, or take the form of an HVAC system.
